(19) United States
(12) Patent Application Publication
(10) Pub. No.: US 2020/0407611 A1
(43) Pub. Date: Dec. 31, 2020

(54) ADHESIVE COMPOSITION

(71) Applicant: DDP SPECIALTY ELECTRONIC MATERIALS US, INC., COLLEGEVILLE, PA (US)

(72) Inventors: Huang Wu, Lake Jackson, TX (US); Sergio Grunder, Freienbach (CH); Stefan Schmatloch, Freienbach (CH); Joel Kunz, Horgen (CH)

(21) Appl. No.: 16/975,223

(22) PCT Filed: Feb. 21, 2019
(86) PCT No.: PCT/US19/18890

§ 371 Date: Aug. 24, 2020

Related U.S. Application Data
(60) Provisional application No. 62/639,675, filed on Mar. 7, 2018.

(51) Int. Cl. C09J 175/08; C08G 18/24; C08G 18/48; C08G 18/76; C08G 18/20

(52) U.S. Cl. CPC C09J 175/08; C08G 18/242; C08G 18/4829; C08K 3/04; C08G 18/2063; C08G 2170/60; C08G 18/7664

(57) ABSTRACT

A polyurethane adhesive composition, more specifically a two-component polyurethane adhesive, including (a) at least one isocyanate component, wherein the isocyanate component comprises (ai) at least one first polyisocyanate compound, and (aii) at least one second polyisocyanate compound having a functionality of greater than, or equal to, about 2.3; and (b) at least one polyol component; and a process for making the above adhesive composition.

### FIELD

The present invention relates to an adhesive composition; and more specifically, the present invention relates to a two-component polyurethane adhesive composition which is particularly useful in automotive applications.

### BACKGROUND

The use of re-enforced composites in modern vehicle design is growing due to performance advantages and light weight vehicle requirements. Adhesive joints are the most preferred assembly technology for composites, as bonding does not destroy the composite structure (other than mechanical fixation, such as for example screwing or riveting). Typically, the use of adhesives technologies for part assembly aims at optimizing production processes so as to achieve a fast adhesive application, rapid strength built-up and fast development of handling strength. In some cases, acceleration of adhesive application, adhesive strength built-up and development of adhesive handling strength can be achieved via heat processes. For example, infrared based heat processes, as opposed to heat curing using a conventional convection oven, can enable very short cycle times of, for example, 1-3 minutes (min) to achieve a lap shear strength of greater than (>) 1.0 Mega-Pascals (MPa).

Additionally, for a process to provide a fast strength built up for an adhesive, flexibility in the process is required. Process flexibility is defined as a long open time. “Open time” is the time lapse between application of the adhesive on a first substrate and the joining of a second substrate to the first substrate. Furthermore, a long mixer stand-alone time is required to reduce flushing intervals and hence reducing the material waste generated by the process. “Mixer stand-alone time” is the period of time a mixed two-part or two-component (2K) adhesive can be kept in a mixer unit (static or dynamic) between two successive applications of the 2K adhesive without the adhesive gelling. After the two components of the 2K adhesive are mixed, it is desirable that the adhesive remain workable for as long as possible such that the adhesive is capable of bonding to a substrate. In addition to long open times, after a 2K adhesive has reached its open time at room temperature (about 25° C.), an adhesive that exhibits a fast strength build-up is desired to provide handling strengths of the adhesive after a short time (for example, one hr or less). The aforementioned adhesives are generally latent adhesives. A “latent adhesive” means a 2K adhesive having a long open time (e.g., >8 min) followed by a fast cure time (e.g., faster than 60 min).

Polyurethanes (PU) are a well-known type of adhesive that come in 2K type; and that may provide some of the benefits described above related to open time and fast cure time. It is also known that a 2K PU adhesive can be used in a variety of applications; and in one embodiment, the 2K PU adhesive can be advantageously used in the construction of passenger vehicles, particularly when during construction of a passenger vehicle the welding of two dissimilar materials is difficult or even impossible to achieve. Generally, a 2K PU adhesive formulation that consists of a first part: a resin component that includes one or more polyisocyanate compounds; and a second part: a curative component that includes one or more polyol compounds. When the two components are mixed, the polyisocyanate compounds and polyol compounds react to forma cured polyurethane adhesive. A polyurethane adhesive can be formulated to cure at room temperature or upon exposure to certain conditions, an example of which is an elevated temperature. As the adhesive cures, the adhesive can form a strong adhesive bond to many types of substrates. A two-component adhesive composition, such as the 2K PU adhesive, can be particularly useful where rapid cure is required for the application, especially where the two components are not shelf stable when in contact with one another. “Shelf stable” means that the composition does not cure in storage.

There are known 2K PU adhesive compositions and processes for preparing such adhesives. For example, 2K PU adhesive formulations are disclosed in U.S. Pat. No. 4,876,308 and WO2014029891A1. It is also well known that using previous compositions and processes of the prior art, long open times (>8 min) can be achieved, but with such long open times, an undesired low strength build-up after one hr at room temperature (e.g., less than (<) 0.8 MPa lap shear strength) can occur. Or, using known compositions and processes of the prior art, a high one-hr room temperature lap shear strength (e.g., >0.8 MPa) can be achieved, but with such high strength build-up, an undesirable short open time (e.g., <8 min) is obtained. Hence, it is known that open time and room temperature strength build-up correlate diametrically. In other words, known 2K PU adhesive compositions do not exhibit an increase open time and a fast curing rate at ambient temperature, without compromising the adhesive's mechanical properties. Therefore, what is still needed in the industry is a 2K PU adhesive that exhibits an increased latency, i.e., an adhesive that has a longer open time as well as a fast handling strength build up; and at the same time, an adhesive that maintains its mechanical properties.

### SUMMARY

The present invention is directed to a two-component polyurethane (2K PU) adhesive composition (or formulation) including (a) at least one isocyanate component, wherein the isocyanate component (a) comprises (ai) at least a first polyisocyanate compound and (aii) at least a second polyisocyanate compound, wherein the second polyisocyanate compound is a high functional polyisocyanate having a functionality of greater than or equal to (≥) about 2.3; and (b) at least one polyol component, wherein the polyol component (b) includes one or more polyol compounds. In one preferred embodiment, the adhesive composition may include (c) optionally, at least one catalyst; and in another preferred embodiment, the adhesive composition may include (d) optionally, at least one filler. The optional catalyst or optional filler can be added to the isocyanate component (a) and/or to the polyol component (b).

One objective of the present invention is to provide a novel 2K PU adhesive formulation with improved latency without compromising the mechanical properties of the present invention 2K PU adhesive. The present invention also provides a 2K PU adhesive composition that: (1) exhibits an increase open time for working with the adhesive; (2) is capable of being cured at ambient temperature; (3) is capable of bonding to various materials such as aluminum, magnesium, sheet molding compound, carbon fiber composites, and coated metals; and (4) is capable of bonding dissimilar materials.

The 2K PU adhesive composition of the present invention exhibiting beneficial properties can be obtained by increasing the functionality of the isocyanate component (a). The functionality of the isocyanate component (a) can be increased, for example, by adding to the isocyanate component (a) a high functional polyisocyanate compound (e.g., a compound having a functionality of about 2.3 or more. The process of the present invention significantly departs from conventional processes of preparing a 2K PU adhesive composition; and surprisingly by increasing the functionality of the isocyanate component (a), as described herein, an improvement in both open time and strength build-up at room temperature can be achieved.

### DETAILED DESCRIPTION

“Isocyanate component (a)”, or abbreviated as “IsoC”, herein refers to an ingredient that includes one or more isocyanate functional polyisocyanate compounds wherein at least one of the molecules of polyisocyanate compound has at least one isocyanate (NCO) functional group. The IsoC can be a monomeric or polymeric compound or a mixture of such compounds.

“Polyol component (b)”, or abbreviated as “PolC”, herein refers to an ingredient that includes one or more polyol functional compounds wherein at least one of the molecules of the polyol functional compound has at least one polyol functional group. The PolC can be a monomeric or polymeric compound or a mixture of such compounds.

In one general embodiment, the present invention includes a polyurethane adhesive composition, more specifically a 2K PU adhesive, including (a) at least one isocyanate component, wherein the isocyanate component (a) comprises (ai) at least a first polyisocyanate having a functionality of >1; and (aii) at least a second polyisocyanate having a functionality of >2; and (b) at least one polyol component. The novel adhesive of the present invention is directed to the use of a highly functional polyisocyanate compound (e.g., a polyisocyanate compound having a functionality of >2) as the second polyisocyanate compound (aii) and adapted for providing beneficial properties to the adhesive such as longer open time and faster strength build-up. Improved latency of the adhesives of the present invention can be derived from the increased crosslink density which leads to a reduced elongation at break of the adhesive.

It has been surprisingly found that when a second polyisocyanate compound having a high functionality is added to the IsoC to form the adhesive composition of the present invention, the latency of the adhesive composition is improved and the mechanical properties of the adhesive composition are not compromised. It has also been unexpectedly found that when a high functional second polyisocyanate compound is used in the present invention 2K PU adhesive composition exhibits a longer open time and a faster strength build-up without compromising the mechanical properties of the 2K PU adhesive such as elongation at break.

The 2K PU adhesive formulation of the present invention includes at least one isocyanate component, as component (a) of the formulation, i.e., the isocyanate component (a) useful in the present invention may include one or more isocyanate-containing compounds or polyisocyanate compounds. The isocyanate component (a) useful in the present invention can be one or more compounds adapted for reacting with the polyol component (b). In one preferred embodiment, the isocyanate component, component (a), of the adhesive formulation of the present invention comprises (ai) at least a first polyisocyanate compound and (aii) at least a second polyisocyanate compound, wherein the second polyisocyanate compound is different than the first polyisocyanate compound, and wherein the second polyisocyanate compound is a high functional polyisocyanate compound having a functionality of ≥about 2.3.

The polyisocyanate compound useful as the first polyisocyanate compound, component (ai), can include one or more of: (1) at least one isocyanate-containing monomer compound, (2) a mixture of compounds wherein at least one of the polyisocyanate compounds in the mixture is an isocyanate-containing monomer compound, (3) at least one isocyanate-containing polymer compound, or (4) a mixture of an isocyanate-containing monomer compound and an isocyanate-containing polymer compound. For example, the first polyisocyanate compound (ai) useful in the adhesive formulation of the present invention may include any conventional aromatic polyisocyanate, aliphatic polyisocyanate, or mixtures thereof; and the first polyisocyanate compound can be added to the adhesive formulation as a monomer compound or as a polymer (or prepolymer) compound.

The polyisocyanate compound useful as the first polyisocyanate compound, component (ai), generally can have a viscosity of for example from about 10 milli-Pascals seconds (mPa-s) to about 1,000 mPa-s at 25° C. in one embodiment, and from about 200 mPa-s to about 800 mPa-s in another embodiment.

Some embodiments of the aromatic polyisocyanate compounds comprising the first polyisocyanate compound (ai) useful in the present invention include, for example, m-phenylene diisocyanate; methylene diphenyl diisocyanate (MDI); 4,4′-methylene-diphenyldiisocyanate; 2,2′-methylenediphenyl-diisocyanate; 2,4 -methylene-diphenyldiisocyanate; toluene diisocyanate (TDI); toluene-2,4-diisocyanate; toluene-2,6-di-isocyanate; naphthyl-ene-1,5-diisocyanate; methoxyphenyl-2,4-diisocyanate; diphenyl-methane-4,4′-diisocyanate; diphenylmethane-2,4′-diisocyanate; 4,4′-bi-phenylene diisocyanate; 3,3′-dimethoxy-4,4′-biphenyl diisocyanate; 3,3′-dimethyl-4-4′-biphenyl diisocyanate; 3,3′-dimethyl-diphenyl methane-4,4′-diisocyanate; 4,4′,4″-triphenyl methane triisocyanate; polymethyl-ene polyphenylisocyanate (PMDI); toluene-2,4,6-triisocyanate; 4,4′-dimethyl-di-phenylmethane-2,2′,5,5′-tetraisocyanate; and mixtures thereof. Modified aromatic polyisocyanates, such as a derivative of any one or more of the above polyisocyanates that contain urethane, urea, biuret, carbodiimide, uretoneimine, allophonate and/or other groups formed by reaction of isocyanate groups, are also useful in the present invention.

In a preferred embodiment, the aromatic polyisocyanate compound useful in the present invention may include, for example, monomeric MDI; monomeric PMDI; polymeric MDI (a mixture of MDI and PMDI that is commonly referred to as “polymeric MDI”); and so-called “liquid MDI” products that are mixtures of MDI and MDI derivatives that have biuret, carbodiimide, uretoneimine and/or allophonate linkages. Exemplary of an aromatic polyisocyanate compound as the first polyisocyanate compound can be a monomeric MDI such as Isonate® 143 which is a liquified MDI with a functionality of 2.2 and a viscosity of 40 mPa-s. Isonate is a trademark of The Dow Chemical Company and Isonate products are available from The Dow Chemical Company. Mixtures of two or more of the above aromatic polyisocyanates may also be used in the present invention adhesive formulation.

Some embodiments of the aliphatic polyisocyanate compounds comprising the first polyisocyanate compound (ai) useful in the present invention include, for example, cyclohexane diisocyanate; 1,3- and/or 1,4-bis(isocyanatomethyl)cyclohexane; 1-methyl-cyclohexane-2,4-diisocyanate; 1-methyl-cyclo-hexane-2,6-diisocyanate; methylene dicyclohexane diisocyanate; isophorone diisocyanate; hexamethylene diisocyanate (HDI); isophorone diisocyanate (IPDI); and mixtures thereof.

In one preferred embodiment, the aliphatic polyisocyanate compounds useful in the present invention may include HDI-based aliphatic polyisocyanates such as Desmodur N3400 and Desmodur N3300. Desmodur N3400 is HDI-uretdione and is also referred to as an HDI-dimer; and Desmodur N3300 is HDI-isocyanerate and is also referred to as an HDI-trimer. Desmodur is a trademark of Covestro and Desmodur products are available from Covestro. Mixtures of two or more of the above aliphatic polyisocyanates may also be used in the present invention adhesive formulation.

In another embodiment, the polyisocyanate compounds useful as the first polyisocyanate compound (ai) in the present invention adhesive can include, for example, a polymer (or prepolymer) compound which can be the reaction product of a polyisocyanate and a polyol wherein the resulting reaction product has reactive isocyanate moieties present in its chemical structure and wherein such isocyanate moieties can further react with other polyols. Such isocyanate-containing prepolymers (or an isocyanate-terminated prepolymers) that can be useful as the first isocyanate compound (ai) can be prepared by reacting: a polyisocyanate compound and a polyol compound.

The polyisocyanate compounds useful for preparing the prepolymer can be any of the polyisocyanate compounds described above; and the polyol compounds useful for preparing the prepolymer can be selected from a variety of polyol compounds known in the art. For example, any one or more of conventional polyol compounds described herein below with reference to the polyol component (b); and any of the polyols described in WO2016205252(A1), incorporated by reference, can be used in the present invention. The polyol compound, such as poly(propylene oxide), used to make the isocyanate-terminated prepolymer may have a molecular weight (MW) of from about 800 to about 10,000 in one embodiment, a MW of from about 800 to about 8,000 in another embodiment, and a MW of from about 800 to about 6,000 in yet another embodiment. In addition, the polyol may have a nominal functionality of from about 2 to about 3 in one embodiment and a nominal functionality of 2 in another embodiment.

The above reaction of one or more polyisocyanate compounds and one or more polyols compounds can produce isocyanate-containing prepolymer molecules having a polyether segment that is capped with the polyisocyanate, so the molecules have terminal isocyanate groups. Each prepolymer molecule contains a polyether segment that corresponds to the structure, after removal of hydroxyl groups, of a polyol used in the prepolymer-forming reaction. If a mixture of polyols is used to make the prepolymer, a mixture of prepolymer molecules can be formed. For example, in addition to the prepolymer that can be end-capped with a polyol described above, in other embodiments a wide variety of other prepolymers useful in the present invention can be made by molecular weight build-up. For example, the prepolymer can have one diisocyanate in the middle of the chemical structure of the prepolymer with two polyol groups attached to the ends of the structure which can be end-capped with isocyanates.

In one embodiment, for example, the prepolymer may include MDI end-capped prepolymers formed from EO (ethylene oxide) and/or PO (propylene oxide) based polyols such as diols, triols, or mixtures thereof. The resulting prepolymers may have an equivalent weight (EW) of up to about 5,000 in one embodiment, from about 1,000 to about 4,000 in another embodiment, and from about 2,000 to about 3,500 in yet another embodiment.

In another embodiment, the prepolymer may be prepared by combining: (1) a polyol or a mixture of polyols (having any number of polyols) with (2) a polyisocyanate having a low equivalent weight (e.g., an EW of <350) or a mixture of two or more low-EW polyisocyanates. The low EW polyisocyanate compound(s), generally, have an isocyanate EW of up to about 350 in one embodiment, from about 80 to about 350 in another embodiment, from about 80 to about 250 in still another embodiment, from about 80 to about 200 in yet another embodiment, and from about 80 to about 180 in even still another embodiment. The amount of such low-EW polyisocyanate that can be used in the present invention may be significantly greater than is needed to simply cap the polyol(s) with isocyanate moieties.

After reaction, the above combination may produce a mixture of the prepolymer and unreacted starting low-EW polyisocyanate compound(s). If desired, an additional amount of polyisocyanate compound(s) can then be blended into this prepolymer/unreacted low-EW polyisocyanate mixture. For example, the mixture can be combined with one or more aliphatic polyisocyanates, such as an aliphatic polyisocyanate based on hexamethylenediisocyanate.

In another embodiment, the prepolymer may be prepared by combining a mixture of two or more polyisocyanate compounds. If a mixture of polyisocyanates is present in the adhesive formulation, the mixture of polyisocyanates may have, for example, an average of from about 2 to about 4 isocyanate groups per molecule in one embodiment or from about 2.3 to about 3.5 isocyanate groups per molecule. All, or a portion, of the polyisocyanate compound may have aromatic isocyanate groups from any of the above described aromatic polyisocyanate compounds; and all, or a portion, of the polyisocyanate compounds may have aliphatic isocyanate groups from any of the above described aliphatic polyisocyanate compounds.

In still another embodiment, the prepolymer useful as the first polyisocyanate compound (ai) can include a mixture of: (1) one or more prepolymers having at least 2 isocyanate groups per molecule and an isocyanate EW of from about 700 to about 3,500, and (2) one or more of the above-described low EW polyisocyanates. When such prepolymer/low-EW polyisocyanate mixture is prepared, the prepolymer comprising such mixture, may constitute from about 20 weight percent (wt %) to about 80 wt % of the weight of isocyanate component (a) in one general embodiment. In other embodiments, the prepolymer may constitute from about 20 wt % to about 70 wt %, from about 20 wt % to about 65 wt %, or from about 30 wt % to about 60 wt % of the weight of isocyanate component (a). When such a mixture is present, the low EW polyisocyanate may constitute from about 1 wt % to about 50 wt % of weight of the isocyanate component (a). The isocyanate content in the polyisocyanate component (a) may be about 1 wt % or greater, about 6 wt % or greater, about 8 wt % or greater, or about 10 wt % or greater. The isocyanate content in the prepolymers may be about 35 wt % or less, about 30 wt % or less, about 25 wt % or less, or about 15 wt % or less.

In yet another embodiment, the prepolymer may be a reaction product of one or more diisocyanates having an isocyanate EW of up to about 350 with: (1) at least one homopolymer of poly(propylene oxide) or any other polyol (for example, a polyester polyol, polybutylene oxide and the like.) having an EW of from about 700 to about 3,000 and having a nominal hydroxyl functionality of from about 2 to about 4 in one embodiment and a nominal functionality of from about 2 to about 3 in another embodiment; or (2) a mixture of the above component (1) with a polyether polyol having a MW of from about 2,000 to about 8,000. In a preferred embodiment, up to about 3 parts by weight of the above polyether polyol component (2) per part by weight of component (1) can be used. The polyether polyol may include a copolymer of from about 70 wt % to about 99 wt % propylene oxide and from about 1 wt % to about 30 wt % ethylene oxide; and the copolymer may have a nominal hydroxyl functionality of from about 2 to about 4 in one embodiment and a nominal functionality of from about 2 to about 3 in another embodiment. The copolymer may also have a MW of from about 3,000 to about 5,500 in still another embodiment.

At least some of the isocyanate groups present in the polyisocyanate component (a) may be aromatic isocyanate groups. If a mixture of aromatic and aliphatic isocyanate groups is present in the isocyanate component (a), about 50% or more by number are aromatic isocyanate groups in one embodiment and about 75% or more by number are aromatic isocyanate groups in another embodiment. In still another embodiment, from about 80% to about 98% by number of the isocyanate groups may be aromatic, and from about 2% to about 20% by number may be aliphatic isocyanate groups.

The isocyanate groups of the prepolymer may be aromatic, aliphatic (including alicyclic), or a mixture of aromatic and aliphatic isocyanate groups. In a preferred embodiment, the isocyanate groups of the prepolymer molecules may be aromatic. In one embodiment, for example, all of the isocyanate groups of the prepolymer may be aromatic, and the isocyanate groups of the low-EW polyisocyanate compound may be a mixture of from about 80% to about 95% aromatic isocyanate groups and from about 5% to about 20% aliphatic isocyanate groups.

Generally, the prepolymer useful as component (ai) of the present invention adhesive formulation has an isocyanate EW of about 700 to about 3,500 in one embodiment, from about 700 to about 3,000 in another embodiment, and from about 1,000 to about 3,000 in still another embodiment. The EW for purposes of the present invention is calculated by adding the weight of the polyol(s) used to prepare the prepolymer and the weight of polyisocyanate(s) consumed in reaction with the polyol(s), and dividing by the number of moles of isocyanate groups in the resulting prepolymer. In addition, the prepolymer may have about 2 or more isocyanate groups per molecule in one embodiment, from about 2 to about 4 isocyanate groups per molecule in another embodiment, and from about 2 to about 3 isocyanate groups per molecule in still another embodiment.

In general, the amount of the prepolymer useful in the adhesive formulation can be in the range of from about 0.01 wt % to about 80 wt % in one embodiment; from about 1 wt % to about 70 wt % in another embodiment; from about 1 wt % to about 60 wt % in still another embodiment; and from about 1 wt % to about 55 wt % in yet another embodiment, based on the total weight of the components in the formulation. If the amount of the prepolymer is more than 80 wt %, then the formulation's viscosity may be too low for the components in the formulation to mix with each other. If the amount of prepolymer is less than 0.01 wt %, then the adhesive formulation may not function to provide an operable adhesive.

The polyisocyanate compound useful as the second polyisocyanate compound, component (aii), in the adhesive formulation of the present invention, can include one or more polyisocyanate compounds, i.e., the second polyisocyanate compound (aii) may include a single second polyisocyanate compound or a mixture of two or more second polyisocyanate compounds provided that the functionality of the second polyisocyanate compound(s) is ≥about 2.3. The second polyisocyanate compound may include aromatic polyisocyanates, aliphatic polyisocyanates, or mixtures thereof; and the second polyisocyanate compound can be added to the adhesive formulation as a monomer compound or as a polymer compound. The second polyisocyanate compound useful in the present invention may be selected from a variety of polyisocyanate compounds having a functionality of ≥about 2.3 including, for example, polymeric MDI, modified polymeric MDI, a mixture of pure MDI and polymeric MDI, and mixtures thereof.

Generally, the viscosity of the second polyisocyanate compound can be for example from about 10 mPa-s to about 1,000 mPa-s at 25° C. in one embodiment, and from about 200 mPa-s to about 800 mPa-s in another embodiment. In one embodiment, for example, the second polyisocyanate compound (aii) may be selected from one or more of the following: (1) a polymeric MDI with a functionality of 2.7 and a viscosity of 205 mPa-s, such as VORANATE M220, available from The Dow Chemical Company; (2) a modified MDI with a functionality of 2.4 and a viscosity of 95 mPa-s such as ISONATE M 304, available from The Dow Chemical Company; (3) a polymeric MDI with a functionality of 2.7 and viscosity of 190 mPa-s such as VORANTE M229, available from The Dow Chemical Company; (4) a polymeric MDI with a functionality of 2.9 and viscosity of 600 mPa-s such as VORANATE M 590, available from The Dow Chemical Company; a polymeric MDI with a functionality of 2.7 and viscosity of 150 mPa-s such as Lupranate 224, available from BASF; a polymeric MDI with a functionality of 2.7 and a viscosity of 220 mPa-s such as Isonate 220, available from The Dow Chemical Company; and mixtures thereof.

In general, the NCO % of the second polyisocyanate compound can be for example from about 10% to about 45% in one embodiment, from about 20% to about 40% in another embodiment, and from about 25% to about 34% in still another embodiment. For example, in one embodiment, the second polyisocyanate compound can be selected from BASF Lupranate 78 having a NCO % of 32%, a functionality of 2.3 and a viscosity of 65 mPa-s; BASF Lupranate M10 having a NCO % of 32%, a functionality of 2.3 and a viscosity of 70 mPa-s; BASF Lupranate M70L having a NCO % of 31%, a functionality of 3 and a viscosity of 700 mPa-s; BASF Lupranate TF2115 M70L having a NCO % of 32.3%, a functionality of 2.4 and a viscosity of 49 mPa-s; Covestro Desmodur VK10 having a NCO % of 31.5%, a functionality of 2.0-2.8 and a viscosity of 22.5 mPa-s; Covestro Desmodur VKS20 having a NCO % of 31.5%, a functionality of >2.8 and a viscosity of 200 mPa-s; Covestro Desmodur 44V40L having a NCO % of 31%, a functionality of >2.8 and a viscosity of 300 mPa-s; and Covestro Desmodur VL having a NCO % of 31.5% and a viscosity of 90 mPa-s

The second isocyanate compound such as VORANATE M220 may be present in the adhesive formulation at a concentration in the range of from about 2 wt % to about 25 wt % in one embodiment, from about 2 wt % to about 21 wt % in another embodiment, from about 3 wt % to about 14 wt % in still another embodiment, from about 7 wt % to about 14 wt % in yet another embodiment, and from about 10 wt % to about 14 wt % in even still another embodiment. If the amount of the second polyisocyanate compound is more than 25 wt %, then the mechanical properties of the adhesive formulation may be compromised; and if the amount of the second isocyanate compound is less than 2 wt %, then the latency of the adhesive formulation may be compromised.

As aforementioned, the polyol component (b) useful in the present invention may include one or more polyol compounds which can be selected from known polyols such as any of the polyols described in WO2016205252(A1), incorporated by reference. For example, the polyol component (b) may be a polyether polyol or mixture of polyether polyols. In one general embodiment, each polyether polyol has a hydroxyl EW of from about 400 to about 3,000. The hydroxyl EW of each polyol in some embodiments may be at least about 500, at least about 800 or at least about 1,000; and in some embodiments, the hydroxyl EW may be up to about 3,000; up to about 2,500; or up to about 2,000. Each such polyether polyol has a nominal hydroxyl functionality of from 2 to 3. By “nominal functionality” of a polyether polyol, it is meant the average number of oxyalkylatable hydrogen atoms on the initiator compound that is alkoxylated to form the polyether polyol. The actual functionalities of the polyether polyol(s) may be somewhat lower than the nominal functionality, due to side-reactions that occur during the alkoxylation process. In the case of a mixture of polyether polyols, the number average nominal functionality may be from about 2 to about 3 in one embodiment and from about 2.5 to about 3 in another embodiment.

The polyether polyol(s) useful in the present invention as component (b) may be selected from homopolymers of propylene oxide and copolymers of from about 70 wt % to about 99 wt % propylene oxide and from about 1 wt % to about 30 wt % ethylene oxide. Such a copolymer of propylene oxide and ethylene oxide is generally preferred if a single polyether polyol is present. If two or more polyether polyols are present, it is preferred that at least one of the polyols is such a copolymer of propylene oxide and ethylene oxide. In the case of a copolymer, the propylene oxide and ethylene oxide may be randomly copolymerized, block copolymerized, or both. In some embodiments, about 50% or more of the hydroxyl groups of the polyether polyol or mixture of polyether polyols are primary hydroxyl, with the remainder of the hydroxyl groups being secondary hydroxyl groups. In another embodiment, about 70% or more of the hydroxyl groups in the polyether polyol or mixture thereof may be primary hydroxyl groups. The polyether polyol(s) may constitute about 35 wt % or greater of the polyol component (b) in one embodiment, about 40 wt % or greater in another embodiment, and about 50 wt % or greater in still another embodiment. In other embodiments, the polyether polyol(s) of the polyol component (b), may constitute about 80 wt % or less in one embodiment, about 65 wt % or less in another embodiment, and about 55 wt % or less in still another embodiment.

In a preferred embodiment, the polyol can be, for example, a polyetherpolyol or a polyester polyol with an EW of >about 200 g/mol and having a functionality of >about 1. Other suitable polyols useful as the polyol component (b) in the present invention may include for example polypropylene based diols such as Voranol™ 1010L with an EW of about 500 g/mol, Voranol™ 2000L with an EW of about 1,000 g/mol, glycerin-initiated ethylene oxide based propoxylated triol Voranol™ CP4610 with an average EW of about 1,600 g/mol; and mixtures thereof.

“High functional polyols”, that is, polyols with a functionality of >about 2.3 (e.g. >about 3), can also be used in the present invention as polyol component (b). For example, a high functional polyol useful in the present invention may include Voranol 280. Voranol 280 is a sucrose initiated oxypropylene-oxyethylene polyol having a hydroxyl number of 280. Voranol is a trademark of The Dow Chemical Company and Voranol products are available from The Dow Chemical Company.

In another embodiment, the polyol component (b) may be selected from a variety of polyols having a functionality of >about 2 and an EW of <about 200. The polyol component (b) may include, for example, 1,2,3-propanetriol (also known as glycerin) or other isomers of glycerin; 1,2,4-butanetriol (or other isomers of 1,2,4-butanetriol); any other polyol compound with about 3 or more hydroxyl groups and with a MW of <about 600 g/mol; and mixtures thereof.

The adhesive formulation of the present invention may optionally contain at least one chain extender. The optional chain extender can be present in the isocyanate component (a) and/or in the polyol component (b). The chain extender may be one or more aliphatic diol chain extenders. The aliphatic diol chain extender(s) each may have a hydroxyl EW of about 200 or less in one embodiment, about 100 or less in another embodiment, about 75 or less in still another embodiment and about 60 or less in even still another embodiment. The aliphatic diol chain extender may have two aliphatic hydroxyl groups per molecule. And, the chain extender useful in the present invention may include short chain extender diols with an EW of from about 10 to about 59. In one embodiment, examples of the aliphatic diol chain extenders may include monoethylene glycol (MEG), diethylene glycol, triethylene glycol, 1,2-propane diol, 1,3-propane diol, 2,3-dimethyl-1,3-propane diol, dipropylene glycol, tripropylene glycol, 1,4-butane diol, 1,6-hexane diol, other linear or branched alkylene diols having up to about 20 carbon atoms, and mixtures thereof. In a preferred embodiment, the aliphatic diol chain extender may include monoethylene glycol, 1,4-butanediol, and a mixture thereof.

The aliphatic diol chain extender or mixture thereof may be present in an amount of from about 0.1 wt % or greater based on the weight of the components in the formulation in one embodiment, from about 1.0 wt % or greater in another embodiment, from about 2.0 wt % or greater in still another embodiment, and from about 3.0 wt % or greater in yet another embodiment. The chain extender may be present in an amount of from about 10 wt % or less in one embodiment, from about 9 wt % or less in another embodiment, from about 8 wt % or less in still another embodiment, from about 7 wt % or less in yet another embodiment, and from about 6 wt % or less in event still another embodiment.

While the second part of the 2 k PU adhesive has been described with reference to a “polyol” component (b), it is well known that other isocyanate-reactive compounds can be used in the present invention. The term “isocyanate-reactive compound” as used herein includes any organic compound having nominally at least two isocyanate-reactive moieties. An “isocyanate-reactive moiety” herein refers to a moiety that can be an active hydrogen-containing moiety; and an “active hydrogen-containing moiety” herein refers to a moiety containing a hydrogen atom which, because of its position in the molecule, displays significant activity according to the Zerewitinoff rest described by Wohler in the Journal of the American Chemical Society, Vol. 49, p. 3181 (1927). Illustrative of such isocyanate-reactive moieties, such as active hydrogen-containing moieties, are —COOH, —OH, —NH₂, —NH—, —CONH₂, —SH, and —CONH—. Exemplary active hydrogen-containing compounds, i.e., isocyanate reactive moiety containing compounds, useful in the present invention, may include polyols, polyamines, polymercaptans and polyacids. In a preferred embodiment, the isocyanate-reactive compound useful in the present invention, is a polyol compound; and in another preferred embodiment, the polyol compound can be a polyether polyol compound.

In general, the amount of the polyol component (b) in the adhesive formulation can be in the range of from about 0.1 wt % to about 90 wt % in one embodiment; from about 1 wt % to about 80 wt % in another embodiment; from about 2 wt % to about 70 wt % in still another embodiment; from about 5 wt % to about 60 wt % in yet another embodiment and from about 7 wt % to about 50 wt % is even still another embodiment, based on the total weight of the components in the formulation. If the amount of the polyol is more than 90 wt %, then the viscosity of the resulting formulation would be too low and/or the mechanical properties of the adhesive formulation may be compromised. If the amount of the polyol is less than 0.1 wt %, then the OH-number of the polyol component (b) would not be sufficient to provide the appropriate latency and/or the mechanical properties of the adhesive formulation would be compromised.

The adhesive formulation of the present invention may optionally contain at least one catalyst. The optional catalyst can be present in the isocyanate component (a) and/or in the polyol component (b). While the catalyst is optional in the present invention, the catalyst is usually present in the composition to accelerate the reaction of the polyol and isocyanate components. The catalyst may include, for example, one or more latent room temperature (about 25° C.) organometallic catalysts. The latent room temperature organometallic catalysts may contain tin, zinc or bismuth. For example, the latent room temperature organometallic catalyst may include one or more catalysts from the following group of: zinc alkanoates, bismuth alkanoates, dialkyltin alkanoates, dialkyl tin mercaptides, dialkyl tin bis(alkyl-mercaptoacetates), dialkyltin thioglycolates, and mixtures thereof.

In one embodiment, the catalyst useful in the present invention may be a tin-containing (or tin-based) latent room temperature organometallic catalyst such as the aforementioned one or more catalysts selected from the group of: dialkyl tin mercaptides, dialkyl tin bis(alkylmercaptoacetates), dialkyltin thioglycolates, and mixtures thereof. For example, the latent tin-containing organometallic catalysts useful in the present invention adhesive composition may include one or more tin-based catalysts selected from dioctyltinmercaptide; dibutylmercaptidem; dibutylmercaptide; bis(dodecylthio)dimethylstannane; dimethytin bis(2-ethylhexylmercaptoacetate); dioctylcarboxylates; dioctyltinneodecanoate; and mixtures thereof.

Another catalyst useful in the adhesive formulation of the present invention includes for example, any catalyst that can be further heat activated (referred to as “thermosensitive catalysts”). In one embodiment, such thermosensitive catalysts may include for example amines-based solid amine catalysts such as one or more cyclic amidine catalyst compounds selected from the group of: 1,8-diazabicyclo[5.4.0] undec-7-ene (DBU); 1,5-diazabi-cyclo[4.3.0]non-5-ene; and mixtures thereof.

In another embodiment, the adhesive formulation of the present invention may include a combination of at least one of the above latent tin-containing catalysts and at least one of the above thermosensitive amine-based catalysts. Both the tin-containing organic catalyst and the amine-based catalyst can be readily formulated into the isocyanate component (b), the polyol component (c), or both the isocyanate component (b) and the polyol component (c), to form the 2K PU adhesive of the present invention.

In still another embodiment, any non-tin-based metal-organic catalyst which exhibits a similar curing kinetics/profile of the tin-based catalyst described above may be used as the catalyst ingredient in the adhesive formulation of the present invention. For example, useful bismuth-based catalysts may include bismuth(III)-neodecanaote; and useful zin-based catalysts may include zinc-neodecanaote; and mixtures of these catalysts.

In yet another embodiment, non-tin-based catalysts or non-amine-based catalysts useful in the present invention may include carboxylic acid blocked catalysts such as DBU carboxylic acid blocked catalysts. For example, a DBU carboxylic acid blocked catalyst useful in the present invention may include TOYOCAT DB41 (a carboxylic DBU salt available from TOSOH), POLYCAT SA-102/10 (a carboxylic DBU salt available from Air Products), and mixtures thereof. Other catalysts useful in the present invention may include acid blocked amines including for example tertiary amines and organic acid-based catalysts such as TOYOCAT DB40, TOYOCAT DB60, and TOYOCAT DB70 available from TOSOH; 1H-1,2,4-triazole-based amine catalysts such as TOYOCAT DB30 available from TOSOH; and mixtures thereof. Any other known thermosensitive amine catalysts may also be used in the present invention such as TOYOCAT F22 available from TOSOH; triethylenediamine (TEDA); and the like; and mixtures thereof. In one preferred embodiment, the catalyst useful in the present invention may be selected, for example, from tin catalysts such as di-n-octyltin bis[isooctylmercaptoacetate]; from amine catalysts such as POLYCAT SA 1/10, and TOYOCAT DB60; and mixtures thereof. A tertiary amine activator may also be added to the adhesive formulation. The amine activator may include for example 2,4,6-tri(dimethyl-aminomethyl) phenol such as Ancamine K54, available from Air Products. In another preferred embodiment, diazabicycloundecene (DABCO) or triethylenediamine (TEDA) may be used as a catalyst.

In general, the amount of the catalyst in the adhesive formulation can be in the range of from about 0.005 wt % to about 2.0 wt % in one embodiment; from about 0.01 wt % to about 1.0 wt % in another embodiment; and from about 0.015 wt. % to about 0.065 wt % in still another embodiment, based on the total weight of the components in the formulation. In one illustrative embodiment, for example when a tin catalyst such as di-n-octyltin bis[isooctyl-mercaptoacetate] is used in the adhesive formulation, the concentration of such catalyst in the formulation can be from about 0.005 wt % to about 1.0 wt % in one embodiment; from about 0.02 wt % to about 0.08 wt % in another embodiment; and from about 0.03 wt. % to about 0.05 wt % in still another embodiment based on the MW of the tin catalyst di-n-octyltin bis[isooctylmercaptoacetate].

In another illustrative embodiment, for example, when a thermosensitive amine catalyst such as POLYCAT SA 1/10 is used in the adhesive formulation, the concentration of such catalyst in the formulation can be from about 0.01 wt % to about 2.0 wt % in one embodiment; from about 0.01 wt % to about 1.0 wt % in another embodiment; and from about 0.015 wt. % to about 0.025 wt % in still another embodiment based on the MW of the POLYCAT SA 1/10.

In still another illustrative embodiment, for example, when a catalyst such as TOYOCAT DB60 is used in the adhesive formulation, the concentration of such catalyst in the formulation can be from about 0.01 wt % to about 2.0 wt % in one embodiment; from about 0.01 wt % to about 1.0 wt % in another embodiment; and from about 0.045 wt. % to about 0.065 wt % in still another embodiment based on the MW of the TOYOCAT DB60.

If the concentration of the catalyst is lower than about 0.005 wt %, the catalyst used may not be effectively active in the formulation and the storage stability of the resulting formulation may be “poor”, that is, for example, any residual water present in the formulation can deactivate the small amounts of catalyst. If the concentration of the catalyst is more than about 2.0 wt %, the reaction of the components present in the formulation may be too quick resulting in a short open time, that is, an open time of for example less than 3 min may occur. In addition, a high catalyst level (e.g., >2.0 wt %) in the formulation may lead to an increase in handling and formulation costs for the resulting formulation.

The adhesive formulation of the present invention may optionally contain at least one filler. The optional filler can be at least one particulate filler. The particulate filler is a solid material at room temperature, is not soluble in the other ingredients of the polyisocyanate component (a) or in the polyol component (b) or any ingredient thereof. The filler is a material that does not melt, volatilize or degrade under the conditions of the curing reaction between the polyol and polyisocyanate components. The filler may be, for example, an inorganic filler such as glass, silica, fumed silica, boron oxide, boron nitride, titanium oxide, titanium nitride, fly ash, calcium carbonate, and various alumina-silicates including clays such as wollastonite and kaolin, and the like; metal particles such as iron, titanium, aluminum, copper, brass, bronze and the like; thermoset polymer particles such as polyurethane, cured particles of an epoxy, phenol-formaldehyde, or cresol-formaldehyde resin, crosslinked polystyrene, and the like; thermoplastics such as polystyrene, styrene acrylonitrile copolymers, polyimide, polyamide-imide, polyether ketone, polyether-ether ketone, polyethyleneimine, poly(p-phenylene sulfide), polyoxymethylene, polycarbonate and the like; and various types of carbon such as activated carbon, graphite, carbon black and the like; and mixtures thereof.

The particulate filler may be in the form of particles having a size of from about 50 nanometers (nm) to about 100 micrometers (μm) in one general embodiment. In other embodiments, the fillers may have a particle size (d50) of about 250 nm or greater in one embodiment, about 500 nm or greater in another embodiment, and about 1 μm or greater in still another embodiment. In other embodiments, the fillers may have a particle size (d50) of about 50 μm or less in one embodiment, about 25 μm or less in another embodiment, or about 10 μm or less in still another embodiment. Particles sizes are conveniently measured using dynamic light scattering methods, or laser diffraction methods for particles having a size below about 100 nm.

In some embodiments, particulate filler particles may have, for example, an aspect ratio of up to about 5 in one embodiment, an aspect ratio of up to about 2 in another embodiment, and an aspect ratio of up to about 1.5 in still another embodiment. In other embodiments, a portion or all of the filler particles can be grafted onto one or more of the polyether polyol(s) of the polyol component.

In general, when a filler is present in the adhesive formulation, the filler constitutes no more than about 80 wt % of the total weight of the adhesive formulation in one embodiment. In other embodiments, the amount of the filler present in the adhesive formulation can be generally in the range of from about 0.1 wt % to about 80 wt % in one embodiment; from about 0.1 wt % to about 70 wt % in another embodiment; from about 0.1 wt % to about 60 wt % in still another embodiment; from about 0.1 wt % to about 50 wt % in yet another embodiment; from about 0.1 wt % to about 40 wt % in even still another embodiment; from about 0.1 wt % to about 30 wt % in even yet another embodiment; from about 0.1 wt % to about 25 wt % in even still another embodiment; and from about 0.1 wt % to about 20 wt % in even yet another embodiment, based on the total weight of the components in the formulation.

The optional filler can be present in the isocyanate component (a) and/or in the polyol component (b). For example, in one illustrative embodiment of the present invention, the filler may be carbon black and a predetermined concentration of the carbon black can be present in the isocyanate component (a). When carbon black and no other filler is present in the isocyanate component (a), the carbon black filler may constitute, for example, from about 1 wt % to about 50 wt % of the isocyanate component (a) in one embodiment; from about 2 wt % to about 40 wt % in another embodiment; from about 5 wt % to about 30 wt % in still another embodiment; and from about 10 wt % to about 25 wt % in yet another embodiment, based on the weight of the isocyanate component (a).

In another illustrative embodiment of the present invention, a predetermined concentration of filler can be present in the polyol component (b). When a filler is present in the polyol component (b), the filler may constitute, for example, from about 1 wt % to about 80 wt % of the polyol component (b) in one embodiment; from about 5 wt % to about 70 wt % in another embodiment; from about 10 wt % to about 60 wt % in still another embodiment; and from about 20 wt % to about 60 wt % in yet another embodiment, based on the weight of the polyol component (a).

The filler present in the polyol component (b) may be the same as the filler in the isocyanate component (a); or the filler present in the polyol component (b) may be different from the filler in the isocyanate component (a). For example, in one preferred embodiment, a carbon black filler may be used in the isocyanate component (a) in a concentration of, for example, from about 15 wt % to about 20 wt %; and a calcinated clay, calcium carbonate, or talc may be used in the polyol component (b) in an amount of, for example, from about 30 wt % to about 60 wt %. The filler can be readily formulated into the isocyanate component (a), the polyol component (b), or both the isocyanate component (a) and the polyol component (b), to form the 2K PU adhesive of the present invention.

The adhesive formulation of the present invention may further include one or more other optional components which can be present in the polyol component and/or the isocyanate component. For example, another optional ingredient useful in the present invention may include one or more dispersing aids, which wet the surface of the filler particles and help them disperse into the polyether polyol(s). These may also have the effect of reducing viscosity. Among these dispersing aids are, for example, various dispersing agents sold by BYK Chemie under the BYK, DISPERBYK and ANTI-TERRA-U tradenames, such as alkylammonium salt of a low-MW polycarboxylic acid polymer and salts of unsaturated polyamine amides and low-molecular acidic polyesters, and fluorinated surfactants such as FC-4430, FC-4432 and FC-4434 from 3M Corporation. When present in the polyol component, the above dispersing aids may constitute, for example, up to about 2 wt % of the polyol component in one embodiment and up to about 1 wt % of the polyol component in another embodiment.

Another useful optional ingredient useful in the present invention, particularly when used in the polyol component, may include a desiccant such as fumed silica, hydrophobically modified fumed silica, silica gel, aerogel, various zeolites, molecular sieves, and the like; and mixtures thereof. For example, when present in the polyol component, one or more desiccants may constitute about 1 wt % or greater based on the weight of the polyol component in one embodiment, about 5 wt % or less of the polyol component in another embodiment, and about 4 wt % or less of the polyol component in still another embodiment. In other embodiments, the desiccants may be absent from the polyol component or from the adhesive composition.

Optionally, the adhesive formulation of the present invention may be formulated with a wide variety of other optional additives to enable performance of specific functions while maintaining the excellent benefits/properties of the present adhesive product. For example, in one embodiment, the optional additives useful in the formulation may include gas- and water-scavengers to avoid additional water uptake of the adhesive and to avoid NCO-water reaction. Such undesired reaction may result in blister formation in the adhesive due to CO₂ emission caused by the reaction of NCO with water. In another embodiment, compatibilizers may be used in the formulation to further improve the wetting performance as well as to improve the mixing between the polyol component and the isocyanate component.

In still another embodiment, chemical rheology modifiers may be used in the formulation. Generally, for example, different grades of polyamine compounds with different MWs and functionalities can be used in the present invention. In one embodiment, the polyamine compounds include for example any one of more of the following compounds: the trimer Jeffamine T 403 having a MW of 403 g/mol, the dimer Jeffamine D 400 having a MW of 400 g/mol, the dimer Jeffamine D200 having a MW of 200 g/mol, and mixtures thereof. Chemical rheology modifiers can be used in the present invention to provide a fast initial gelling of the formulation which in turn provides the benefit of good sag resistance. Additionally, the fast increase of viscosity upon curing the formulation reduces the risk of CO₂ formation in a heat accelerated curing process. Mixtures of additional optional compounds or additives may be added to the adhesive formulation of the present invention as desired.

The optional component, when used in the adhesive formulation, can be present in an amount generally in the range of from 0 wt % to about 15 wt % in one embodiment; from about 0.1 wt % to about 10 wt % in another embodiment; and from about 1 wt % to about 5 wt % in still another embodiment. In one preferred embodiment, when a molecular sieve is used, the amount of molecular sieve can be for example from about 1 wt % to about 5 wt %. In another preferred embodiment, when an amine product such as Jeffamine product is used, the amount of Jeffamine can be for example from about 0.1 wt % to about 2 wt %.

In one broad embodiment, the process for preparing the 2K PU adhesive formulation of the present invention includes providing at least one isocyanate component (a), and providing at least one polyol component (b) as described above. When the adhesive of the present invention is ready to be used to bond substrates together, the above components (a) and (b) can be mixed, admixed or blended together which results in a reaction product when the combination of components (a) and (b) are cured. One or more additional optional components may be added to the formulation as desired. For example, at least one catalyst and/or at least one filler may be added to the adhesive formulation in either component (a), component (b), or both before the components (a) and (b) are mixed together or after the components (a) and (b) are mixed together.

While the amount of the isocyanate component (a) and the amount of the polyol component (b) useful in making the reaction product constituting the adhesive formulation can vary, once the isocyanate component (a) and the polyol component (b) are formulated (separately and individually) and the two components are ready for combining to form the reaction product adhesive, the isocyanate component (a) and the polyol component (b) are generally mixed at a 1:1 ratio by volume. For example, the ratio of the isocyanate component (a) to the polyol component (b) can be in the range of from about 2:198 to about 198:2 in one embodiment, from about 5:195 to about 195:5 in another embodiment, from about 10:190 to about 190:10 in still another embodiment, from about 20:180 to about 180:20 in yet another embodiment, and in a preferred embodiment the ratio can be about 100:100. If the concentration ratio of the isocyanate component to the polyol component is lower than about 2:198, the adhesive formulation may not exhibit effective adhesion or the adhesion may be poor or nonexistent. If the concentration ratio of the isocyanate component to the polyol component is more than about 198:2, the formulation may not exhibit good mechanical properties or good rheological properties; and/or a high amount of NCO may form in the formulation which may detrimentally lead to a brittle product, i.e., a product having a low elongation to break property.

In making component (a) and component (b), separately and individually, the required ingredients and the optional ingredients that can be mixed together in the desired concentrations discussed above and at a temperature of from about 5° C. to about 80° C. in one embodiment; from about 10° C. to about 60° C. in another embodiment; and from about 15° C. to about 50° C. in still another embodiment. In one preferred embodiment, the mixing of the above ingredients to form components (a) and (b) may be carried out under vacuum. The order of mixing of the ingredients is not critical and two or more compounds can be mixed together followed by addition of the remaining ingredients. The adhesive formulation ingredients that make up components (a) and (b) may be mixed together by any known mixing process and equipment.

In another broad embodiment, the present invention includes a process of bonding two substrates, comprising forming a layer of the 2K PU adhesive at a bondline between two substrates, and curing the layer at the bondline to form a cured adhesive bonded to each of the substrates. For example, the process may comprise combining the polyisocyanate component (a) with the polyol component (b) of the two-component polyurethane adhesive, forming a layer of the adhesive at a bondline between two substrates to form an assembly, allowing the adhesive layer to partially cure at the bondline at room temperature or by applying heat or infrared radiation to a portion of the assembly, and, in a subsequent and separate curing step, completing the cure of the adhesive layer.

The application of the 2K PU adhesive to the substrates to be adhered together can be carried out by any known equipment such as metering/mixing/dispensing equipment which can apply a predetermined amount of the polyisocyanate component (a) and the polyol component (b), in combination (as an adhesive), to selective portions of the substrates. For example, in an automotive manufacturing process, components (a) and (b) are provided in two separate, several gallon-sized tank containers. Then component (a) is drawn from one tank and, at the same time, component (b) is drawn from another tank and both streams are combined together using a known static or dynamic mixer as the combined adhesive components (a) and (b) are applied to the substrates. The partial curing step can be performed by curing only one or more predetermined, localized portions of the adhesive layer at the bondline by applying heat only to the one or more predetermined, localized portions of the assembly to produce an adhesive layer having at least partially cured portions and uncured portions, and the uncured portions of the adhesive layer then can be cured in the subsequent and separate curing step.

In one general embodiment, the process of adhering at least a first substrate to at least a second substrate may comprise the steps of: (1) contacting the polyol component (b) and the isocyanate component (a) as disclosed herein and mixing the components to form a homogeneous adhesive mixture; (2) applying the adhesive mixture to at least a portion of the first substrate; (3) contacting a second substrate with the first substrate such that the mixture is disposed between the first and second substrate forming a bondline; and (4) exposing at least a portion of the mixture to heat under conditions such that the mixture partially cures sufficiently such that the first and second substrate are bonded sufficiently, i.e., with a sufficient strength, such that the substrates can be moved. The process may further comprise a step (5) of heating the two partially cured substrates at a temperature for a time to fully cure the mixture so as to fully bond the two substrates together. The heat may be applied in step (4) by any known heating means such as by infrared heating. The time between steps (4) and (5) may be about 1 hr or more in one embodiment and about 24 hrs or more in another embodiment; and any time in between the above two time periods or more in still other embodiments.

By curing the 2 k PU adhesive composition of the present invention, a structure is formed comprising two or more substrates bonded together with the cured adhesive based. on the curable adhesive composition disclosed herein wherein the cured adhesive is disposed between portions of each of the substrates. In one embodiment, the substrates may comprise dissimilar substrates, i.e., substrates of different materials selected from materials such as metal, glass, plastics, thermoset resins, fiber reinforced plastics, or mixtures thereof. In one preferred embodiment, one or both of the substrates may be fiber reinforced plastic.

One of the advantages of the formulation of the present invention is that a good latency can be achieved while maintaining the mechanical properties of the formulation. While other approaches for increasing latency have previously been tried, for example by using other ingredients such as Voranol 280, such previous attempts lead to the sacrifice of mechanical properties of the adhesive, for example, an elongation at break of <150% is achieved. The formulation of the present invention, on the other hand, can achieve a long open time of >8 min, a high lap shear strength after 1 h RT of >2 MPa while having an elongation at break of >150% in one embodiment.

The adhesive formulation of the present invention produced by the process of the present invention has several advantageous properties and benefits compared to conventional adhesive formulations. For example, some of the properties exhibited by the adhesive formulation can include increased latency, longer open times, and faster handling strength build up. A two-component polyurethane adhesive for latent ambient temperature cure can be used to improve the latency and can be used to increase the stability of the adhesive formulation system.

For example, longer open times are exhibited by the adhesive and the open times can be generally >about 8 min in one embodiment, >about 9 min in another embodiment, and >about 10 min in still another embodiment. In other embodiments, the open time exhibited by the formulation of the present invention can be in the range of from >about 8 min to about 20 min in one embodiment; from about 9 min to about 20 min in another embodiment; and from about 10 min to about 20 min in still another embodiment

It is advantageous that the adhesive of the present invention has high application shear strengths values. For example, the handling strength build-up, as measured by lap shear strength after 1 h RT, of the adhesive formulation of the present invention can be generally >about 1 MPa in one embodiment, >about 1.5 MPa in another embodiment, and >about 2 MPa in still another embodiment. In yet other embodiments, the lap shear strength after 1 hr RT of the adhesive formulation may be in the range of from about 1 MPa to about 4 MPa in one embodiment, from about 1.5 MPa to about 4 MPa in another embodiment; and from about 2 MPa to about 3 MPa in another embodiment.

The adhesive formulation of the present invention beneficially can be subjected to heat accelerated curing (e.g., after a 3-minute heating cycle) to quickly provide the above handling strength build-up and increased lap shear strengths. A substrate assembly may be exposed to a heat source (e.g., an IR source) and heated during a 120-seconds curing process to reach an adhesive temperature of from about 80° C. to about 120° C. for a time period of from about 5 seconds (s) to about 30 s in one embodiment; and from about 100° C. to about 110° C. for a time period of from about 10 s to about 20 s in another embodiment.

The two-component polyurethane adhesive of the present invention advantageously has high strength and extensibility; and the mechanical properties are not significantly dependent on the temperature of cure. For example, the adhesive formulation of the present invention can provide an adhesive that exhibits an elongation at break of >about 150% in one embodiment, >about 170% in another embodiment, and >about 200% in still another embodiment. In other embodiments, the elongation at break of the adhesive may be for example, from >about 150% to <about 600%, from >about 150% to about 300% in another embodiment, and from about 170% to about 200% in still another embodiment.

In another embodiment, the 2K PU adhesive of the present invention may have an E-Modulus of from about 20 MPa (at 23° C.) to about 100 MPa and from about 30 MPa to about 90 MPa in still another embodiment. The 2K PU adhesive of the present invention also exhibits a low loss of E-Modulus between a temperature range of from about −30° C. and about 90° C. in one embodiment; and from about −35° C. and 80° C. in another embodiment.

Advantageously, the 2K PU adhesive of the present invention can be suitable as a structural adhesive. The 2K PU adhesive of the present invention can be used, for example, to bond together composites; coated metals such as e-coated steel, e-coated aluminum and the like; and sheet-molded compounds (SMC); and mixtures of such materials. Thus, the 2K PU adhesive of the present invention is useful in various applications where bonding of various substrates is needed; and particularly, when the bonding two dissimilar substrates is needed. In one preferred embodiment, the adhesive of the present invention is used in bonding various substrates (or parts) in automotive manufacturing applications.

### EXAMPLES

The following examples are presented to further illustrate the present invention in detail but are not to be construed as limiting the scope of the claims. Unless otherwise stated all parts and percentages are by weight.

Various raw materials used in the examples are explained as follows:

Desmodur N3400, available from Covestro, is an aliphatic polyisocyanate based on hexamethylenbisisocyanate.

Isonate M143 is a liquified MDI with a functionality of 2.2 and a viscosity of 40 mPa-s viscosity. Isonate M143 is available from The Dow Chemical Company (Dow).

Isonate M342 is a polymeric MDI with a functionality of 2 and a viscosity of 580 mPa-s viscosity, available from Dow.

VORANATE M220 is a polymeric MDI with a functionality of 2.7 and a viscosity of 205 mPa-s viscosity, available from Dow.

Metatin T713 is a tin based dibutyltinmercaptide catalyst; and is available from ACIMA.

Di-n-octyltin bis[isooctylmercaptoacetate], a tin based dioctyltinmercaptide catalyst.

POLYCAT SA-1/10 is a solid DBU (1,8-Diazabicyclo[5.4.0]undec-7-ene) based solid amine catalyst with a phenolic counter ion; and is available from ACIMA.

Ancamine K54, 2,4,6-Tri(dimethylaminomethyl) phenol is a tertiary amine activator, available from Air Products.

Voranol 2000L is a polypropylene homopolymer with an average MW of 1,000 g/mol and an OH number of approximately 55 mg KOH/g; and is available from Dow.

Voranol CP4610 is a glycerin-initiated ethylene oxide based propoxylated triol with an average MW of 1,800 g/mol and an OH number of approximately 35 mg KOH/g; and is available from Dow.

1,4 butanediol is available from Arco Chemical and distributed by Schweizerhall Chemie.

Polestar 200R is calcined China clay (55% SiO₂, 45% Al₂O₃) with an average particle size of approximately 2 micrometer (μm) (90%>10 μm), and a BET surface of 8.5 m²/g and a pH of 6.0-6.5. Polestar 200R is available from IMERYS.

Aerosil R 202 is hydrophobically modified polydimethylsiloxane coated fumed silica; and is available from Evonik Industries.

Printex 30 is a carbon black filler supplied by Alzchem.

Toyocat DB60 is a catalyst based on a salt of a tertiary amine with an organic acid; and is commercially available from Tosoh.

Vestinol 9 is 100% di-isononyl-phthalate and used as a plasticizer in T-715 prepolymer technologies; and is available from Evonik.

Voranol 280 is a sucrose initiated oxypropylene-oxyethylene polyol having a hydroxyl number of 280, a functionality of 7, a MW of 400 g/mol, and an EW of 200. VORANOL 280 is available from Dow.

VORAFORCE™ 5300 is a Dow resin grade to produced carbon fiber reinforced composites (CFRP) parts in a RTM process, available from Dow.

BETAWIPE™ 4800 is a solvent based adhesion promoter available from Dow Automotive Systems.

The following tests were conducted according to procedures known to those skilled in the art.

### Open Time

An adhesive bead of 30 cm-50 cm length was manually extruded onto a polyethylene foil. Manual application of 2K polyurethane adhesives was done from a double cartridge application guns, such as for example a Kroger TS 400 with a mounted static mixer unit 8 millimeters (mm) or 10 mm diameter and 24 mixing elements and an application pressure of minimum 6 bar. The applied adhesive bead is compressed successively with a wooden spatula until no adhesive sticks any longer to the wooden surface of the wooden spatula. The measured time is defined as “open time” of the adhesive.

### Reactivity

The reactivity of the 2K PU adhesive is measured by rheology in oscillating mode with a parallel plate 20 mm in diameter, 1 mm plate distance set-up. The reactivity measurements are done at 10 hertz (Hz) with a constant deformation of 0.062%. The complex viscosity is plotted against the time; and the time at which the slope of viscosity is changed more than 30° is considered to be “the reactivity”.

### Shear Strength

Shear strengths measurements were performed according to DIN EN 1465 (July 2009) on a suitable shear strength measuring device such as for example shear strength device Zwick 1435 with a FHM 8606.00.00 or 8606.04.00 mounting device. E-coat substrates were Cathoguard 500 e-coated steel panels with the following dimensions: 100 mm×25 mm×0.8 mm E-coated substrates were cleaned with BETACLEAN™ 3350 (heptane) cleaning solvent solution. The flash-off time of the solvent after cleaning prior to adhesive application was 5 min. CFRP substrates were VORAFORCE™ grade panels from Dow (CFRP VORAFORCE™ 5300) with the following dimensions: 100 mm×45 mm×2.2 mm The CFRP substrates were grinded or used without cleaning or mechanical pretreatment. When grinding was done, the grinding was done manually, using a 320 grinding pad on wet CFRP panels until homogeneous optical appearance is achieved. The panels are successively dried for 8 hrs at 80° C. An adhesive bond dimension of 10 mm×25 mm×1.5 mm was used for the lap shear specimens. The lap shear specimens were tested after 1 hr of curing time at 23° C./50% r.h. or respectively after the following described heat accelerated curing process.

### Heat Accelerated Curing

For heat accelerated curing, an assembly of e-coated steel substrates (KTL) such as an assembly of KTL-KTL lap shear specimens are placed after assembly in an IR curing equipment. Lap shear test specimens useful in this test can also include an assembly of carbon fiber reinforced plastics (CFRP), a CFRP-CFRP assembly, or a CFRP-e-coated steel assembly.

Lap shear specimens are built up with a bond height of 1.5 mm and an overlap area of 45 mm×10 mm The CFRP substrate, exposed to the IR source is heated during a 120-seconds curing process in such a way, that 100° C.-110° C. adhesive temperature is reached for a time period of 10 s-20 s.

### Tensile Tests

Tensile tests were performed with 7d RT cured 2 mm thick plaques (referred to as Dogbones 5A) in accordance with the tests described in DIN 527-2 (June 2012).

The Examples which follow illustrate the use of a high functional polyol (e.g., Voranol 280) in the polyol component (b) of a 2K PU adhesive composition; and the use of a high functional polyisocyanate compound in the isocyanate component (a) of the 2K PU adhesive composition. The use of the high functional polyisocyanate compound unexpectedly increases open time and 1-hr curing strength of the adhesive composition.

### Examples 1-8 and Comparative Examples A-D

Table I which follows describes the recipes for Comparative Examples A-D and Inventive Examples 1-8; and the results of performance data after testing the adhesive compositions. The open time of the adhesive compositions of Comparative Examples A-D and Examples 1-8 was measured by the rheology reactivity test described above. The lap shear strengths were measured at 1 hr and at 7d RT with e-coated steel substrates. The lap shear (“1 h-lap shear”) strengths were measured with the e-coated steel substrates having an adhesion dimensions of 15 mm×25 mm×1.5 mm Tensile tests were performed on Dogbones 5A test samples as described above. The results of the tests performed on Dogbones 5A samples using various adhesives are described in Table I. Lab shear IR heat cure experiments were run with a 180 s heating cycle and with CFK substrates (available from Dow) having adhesion dimensions of 45 mm×15 mm×1.5 mm Tensile properties were measured with a specimen thickness of 2 mm.

It was unexpectedly and surprisingly found that the use of a high functionality polyisocyanate compound in the isocyanate component (a) of the 2K PU adhesive has a more effective impact on the open time and 1-hr curing strength (lap shear strength). The results of the Comparative Examples and Inventive Examples are summarized in Table I. The isocyanate component of Comparative Example A contains Isonate 143 which is a 2.2 functionality polyisocyanate compound; and Comparative Example B contains Isonate 342 which is a 2.0 functionality polyisocyanate compound. Comparative Example C contains a single polyisocyanate compound. Comparative Example D is an adhesive formulation with a high functional polyol component and prepared as described in U.S. Provisional Patent Application No. 62/316680, filed Apr. 1, 2016 (Applicant's Attorney Docket No. 78710).

The Inventive Examples contain an isocyanate component, as component (a), which is a combination of Isonate 220 having a 2.7 functionality and the prepolymer T-715-UK. The combination of the two polyisocyanate compounds provides an overall functionality of isocyanate component (a) in the range from 2 to about 2.6 from the contribution of the aromatic isocyanate functions. There is also 5 wt % of aliphatic isocyanate functions in the isocyanate component (IsoC), provided by Desmodur N3400 (2 functionality) in the Comparative Examples.

The results described in Table I show that the reactivity time increases significantly with the increase of Isonate 220 content, from 470 s for Comparative Example A to 1,310 s for Inventive Example 1. The 1-hr curing lap shear strength (1 h LS) increases with Isonate 220 content from 1.2 MPa (Comparative Example A) to 2.2 MPa (Inventive Example 1). Inventive Example 1 shows a combination of good performance for reactivity and 1 h LS with an acceptable strain at break property. The results described in Table I also show that mechanical property such as Strain to Break suffers when only one high functional polyisocyanate compound is used as component (a) of the adhesive composition (see Comparative Example C).

Further improvement in the adhesive formulation properties may be achieved by incorporating Isonate 342 in the IsoC, such as improving the strain at break property, as shown in Inventive Examples 5 and 6. The high functional IsoC in the adhesive formulations of the present invention (see, e.g., Example 1) are comparable to conventional adhesive formulation in terms of reactivity and 1 h LS.

When the above two approaches are combined, a further improvement in terms of reactivity and 1 h LS of the adhesive composition of the present invention was observed. For example, in Inventive Example 8 reactivity increased from 610 s to 960 s and 1 h LS increased from 1.6 MPa to 2.2 MPa.

The IR curing strength of the Comparative Examples was found to be dependent on the actual adhesive temperature during the IR cure cycle, resulting in obtaining an unreliable curing strength of adhesive at the production line. IR heat is usually applied on the side of the substrate that is opposite of the adhesive; and thus, heat has to conduct through the thickness of the substrate to reach the adhesive, as well as, to conduct through the adhesive bond thickness to ensure thorough cure of the adhesive. Once a predetermined temperature is provided as a set point, the set point can be kept consistent, a change in the substrate material type and/or the thickness of the substrate may cause a variation in the actual adhesive temperature. Thus, it is desired that the adhesive properly cures under a slightly lower temperature than the set point temperature.

TABLE I
Adhesive Compositions and Performance Data

| | Comp. | Comp. | Com. | Comp. | Inv. | Inv. | Inv. | Inv. | Inv. | Inv. | Inv. | Inv. |
|---|---|---|---|---|---|---|---|---|---|---|---|---|
| | Ex.* A | Ex. B | Ex. C | Ex. D | Ex.** 1 | Ex. 2 | Ex. 3 | Ex.4 | Ex.5 | Ex. 6 | Ex. 7 | Ex. 8 |
| POLYOL | | | | | | | | | | | | |
| COMPONENT | | | | | | | | | | | | |
| Voranol | 48.54 | 48.54 | 48.54 | 45.1 | 48.54 | 48.54 | 48.54 | 48.54 | 48.54 | 48.54 | 45.1 | 45.1 |
| CP4610 | | | | | | | | | | | | |
| Voranol 280 | 0 | 0 | 0 | 5 | 0 | 0 | 0 | 0 | 0 | 0 | 5 | 5 |
| 1-4 Butanediol | 5 | 5 | 5 | 4 | 5 | 5 | 5 | 5 | 5 | 5 | 4 | 4 |
| Ancamine K-54 | 0.05 | 0.05 | 0.05 | 0 | 0.05 | 0.05 | 0.05 | 0.05 | 0.05 | 0.05 | 0 | 0 |
| Fomrez UL29 | 0 | 0 | 0 | 0.04 | 0 | 0 | 0 | 0 | 0 | 0 | 0.04 | 0.04 |
| Metatin T713 | 0.07 | 0.07 | 0.07 | 0 | 0.07 | 0.07 | 0.07 | 0.07 | 0.07 | 0.07 | 0 | 0 |
| Polycat SA-1/10 | 0.05 | 0.05 | 0.05 | 0.05 | 0.05 | 0.05 | 0.05 | 0.05 | 0.05 | 0.05 | 0.05 | 0.05 |
| Polestar 200R | 43.19 | 43.19 | 43.19 | 40.3 | 43.19 | 43.19 | 43.19 | 43.19 | 43.19 | 43.19 | 40.3 | 40.3 |
| Printex 30 | 0.6 | 0.6 | 0.6 | 0 | 0.6 | 0.6 | 0.6 | 0.6 | 0.6 | 0.6 | 0 | 0 |
| Molsieb 4A | 1 | 1 | 1 | 4 | 1 | 1 | 1 | 1 | 1 | 1 | 4 | 4 |
| Aerosil R202 | 1.5 | 1.5 | 1.5 | 1.5 | 1.5 | 1.5 | 1.5 | 1.5 | 1.5 | 1.5 | 1.5 | 1.5 |
| ISOCYANATE | | | | | | | | | | | | |
| COMPONENT | | | | | | | | | | | | |
| Isonate M143 | 22.1 | 0 | 0 | 22.5 | 7.1 | 14.4 | 17.5 | 19.8 | 0 | 0 | 0 | 0 |
| Isonate M342 | 0 | 28.4 | 0 | 0 | 0 | 0 | 0 | 0 | 21.5 | 24.9 | 21.5 | 24.9 |
| Isonate M220 | 0 | 0 | 20.9 | 0 | 14.2 | 7.2 | 4.4 | 2.2 | 5.4 | 2.8 | 5.4 | 2.8 |
| Desmodur | 5.0 | 4.6 | 5.1 | 5.0 | 5.1 | 5.1 | 5.0 | 5.0 | 4.7 | 4.7 | 4.7 | 4.7 |
| N3400 | | | | | | | | | | | | |
| Printext 30 | 19.1 | 17.6 | 19.4 | 19.0 | 19.3 | 19.2 | 19.2 | 19.1 | 17.9 | 17.7 | 17.9 | 17.7 |
| T-715-UK | 53.8 | 49.4 | 54.6 | 53.5 | 54.3 | 54.1 | 54.0 | 53.9 | 50.5 | 50.0 | 50.5 | 50.0 |
| RESULTS | | | | | | | | | | | | |
| Open Time/ | 5.0 | 5.0 | 15.0 | 8.5 | 12.0 | 6.0 | 5.5 | 6.0 | 5.5 | 5.5 | 13.5 | 11.0 |
| Tack Free Time | | | | | | | | | | | | |
| (min) | | | | | | | | | | | | |
| Reactivity (s) | 470 | 480 | 1,900 | 610 | 1,310 | 730 | 610 | 530 | 680 | 600 | 1,040 | 960 |
| 1-Hr Curing LS | 1.2 | 0.8 | 2.0 | 1.6 | 2.2 | 1.5 | 1.3 | 1.1 | 0.8 | 0.8 | 1.3 | 2.2 |
| (MPa) | | | | | | | | | | | | |
| IR Curing | 2.4 | 2.9 | 1.9 | 2.2 | 2.1 | 2.2 | — | — | — | — | — | — |
| Strength (MPa) | | | | | | | | | | | | |
| 7d RT LS | 10.0 | — | 7.2 | 8.0 | 8.5 | 7.6 | 11.0 | 9.9 | 12.3 | 12.6 | — | — |
| Strength (MPa) | | | | | | | | | | | | |
| E-Modulus | 21.4 | — | 19.0 | 22.3 | 19.3 | 21.5 | 21.8 | 22.0 | 22.7 | 23.5 | 29.3 | 28.7 |
| (MPa) | | | | | | | | | | | | |
| Strength (MPa) | 12.6 | — | 11.9 | 10.4 | 12.4 | 12.8 | 12.9 | 13.0 | 13.3 | 13.3 | 9.6 | 9.2 |
| Strain at Break | 163 | — | 82 | 158 | 112 | 137 | 146 | 161 | 182 | 204 | 162 | 158 |
| (%) | | | | | | | | | | | | |

*“Comp. Ex.” stands for “Comparative Example” (i.e., not an example of the present invention).
**“Inv. Ex.” stands for “Inventive Example” (i.e., an example of the present invention).

The standard IR curing profile was tuned to 5° C. and 10° C. below the normal set point to investigate the heat curing performance of the formulation of the present invention. The IsoC of the adhesive formulations of Comparative Example B, Inventive Example 6 and Inventive Example 7 were used in combination with the same polyol component (PolC), component (b), in each of the adhesive formulations. As shown in Table II, a significant decrease in lap shear strength was observed for the formulation of Comparative Example B with the decrease of the IR curing temperature, whereas the formulations of Inventive Example 6 and Inventive Example 7 maintain a lap shear strength of above 2 MPa across the investigated temperature range.

TABLE II
IR Curing Performance Data

| | IR Curing Lap Shear Strength | | |
|---|---|---|---|
| | (MPa) | | |
| | Comparative | Inventive | Inventive |
| Profile | Example B | Example 6 | Example 7 |
| IR Profile: Control | 2.9 | 2.4 | 2.4 |
| IR Profile: Control −5° C. | 2.0 | 2.4 | 2.5 |
| IR Profile: Control −10° C. | 1.4 | 2.1 | 2.2 |

As illustrated by the Examples described above, it has been found that, by adding at least one high functional polyisocyanate compound to the isocyanate component (a) of an adhesive formulation which includes at least two polyisocyanate compounds (a first and second polyisocyanate compound), the adhesive formulation of the present invention can be cured at room temperature resulting in: (1) an increase in open time for the adhesive formulation (as monitored by a prolonged viscosity onset and as measured by rheology reactivity); and (2) a high 1-hr lap shear strength of the adhesive formulation. An additional benefit discovered by using the adhesive formulation of the present invention includes an improvement in the reliability of IR curing when the temperature from IR heating is reduced. Heretofore, improvement in reactivity coupled with improvement of 1-hr lap shear strength has not been achieved previously by other means until the development of the adhesive formulation of the present invention.

What is claimed is:

1. An adhesive composition comprising:
(a) at least one isocyanate component, wherein the isocyanate component comprises
(ai) at least one first polyisocyanate compound, and
(aii) at least one second polyisocyanate compound, wherein the at least one second polyisocyanate compound has a functionality of greater than, or equal to, about 2.3; and
(b) at least one polyol component.

2. The composition of claim 1, wherein the at least one second polyisocyanate compound has a functionality of about 2.7.

3. The composition of claim 1, wherein the at least one second polyisocyanate compound is polymeric methylene diphenyl diisocyanate.

4. The composition of claim 1, including further at least one catalyst; and wherein the at least one catalyst is at least one tin-containing organic catalyst.

5. The composition of claim 1, including further at least one filler; and wherein the at least one filler is selected from the group consisting of inorganic filler particles, metal particles, thermoset polymer particles, thermoplastic particles, carbon black, carbon particles, and mixtures thereof.

6. The composition of claim 1, wherein the at least one isocyanate component (a) is present in the composition at a concentration of from about 0.01 weight percent to about 60 weight percent; and wherein the at least one polyol component (b) is present in the composition at a concentration of from about
0.1 weight percent to about 20 weight percent.

7. The composition of claim 1, wherein the adhesive composition has an open time of from greater than 8 minutes; a lap shear strength, after one hour at 23° C. and 50 percent relative humidity, of greater than about 1.0 Mega-Pascal; and an elongation at break of greater than about 150 percent.

8. The composition of claim 1 comprising a two-component polyurethane adhesive.

9. A process for preparing a two-component polyurethane adhesive composition comprising admixing:
(a) at least one isocyanate component, wherein the isocyanate component comprises (ai) at least one first polyisocyanate compound, and (aii) at least one second polyisocyanate compound, wherein the at least one second polyisocyanate compound has a functionality of greater than, or equal to, about 2.3; and
(b) at least one polyol component.

10. A process for adhering at least a first substrate to at least a second substrate comprising:
(I) contacting the at least first substrate with the adhesive composition of claim 1;
(II) contacting the at least second substrate to the adhesive composition present on the at least first substrate; and
(III) curing the at least first and second substrates with the adhesive composition at a temperature of from about 5° C. to about 80° C.
